(19) United States
(12) Patent Application Publication
(10) Pub. No.: US 2018/0184220 A1
(43) Pub. Date: Jun. 28, 2018

(54) SOUND TESTING SYSTEM AND SOUND TESTING METHOD FOR EMBEDDED SYSTEM

(71) Applicant: Primax Electronics Ltd., Taipei (TW)

(72) Inventors: Pei-Ming Chang, Taipei (TW); Shih-Chieh Hsu, Taipei (TW); Shi-Jie Zhang, Taipei (TW); Wei-Lung Huang, Taipei (TW)

(21) Appl. No.: 15/461,491

(22) Filed: Mar. 17, 2017

(30) Foreign Application Priority Data
Dec. 27, 2016 (CN) 201611225592.2

(51) Int. Cl. H04R 29/00; H04R 3/00

(52) U.S. Cl. CPC H04R 29/001; H04R 3/00

(57) ABSTRACT

The present invention provides a sound testing system and a sound testing method for an embedded system. The sound testing system includes: a silencing box, a sound receiving apparatus, and a processing apparatus. The embedded system and the sound receiving apparatus are provided in the silencing box; and the processing apparatus is configured to log in to the embedded system in a manner of remote connection, transmit at least one first sound file to the embedded system and control the embedded system to play the at least one first sound file to generate at least one first sound signal, and receive the at least one first sound signal by means of the sound receiving apparatus, and analyze the at least one first sound signal to verify sound output quality of the embedded system.

### BACKGROUND OF THE INVENTION

### 1. Field of the Invention

The present invention relates to a sound testing system and a relevant sound testing method, and in particular, to a sound testing system and a relevant sound testing method for an embedded system.

### 2. Description of the Prior Art

Generally, conventional sound testing systems and sound testing methods synchronously test a sound output and a sound input of an apparatus to be tested, and therefore, a problem of mutual interference is caused. In addition, the conventional sound testing systems and sound testing methods cannot test an embedded system without an external operating interface (for example, a button or a touch panel).

### SUMMARY OF THE INVENTION

In view of the above, one of objectives of the present invention lies in providing a sound testing system and a sound testing method for an embedded system, so that an embedded system without an external operating interface can also be tested, and a sound output can be separated from a sound input for separate tests to avoid interference, so as to resolve the foregoing problem.

According to the claims of the present invention, the present invention discloses a sound testing system for an embedded system. The sound testing system includes: a silencing box, a sound receiving apparatus, and a processing apparatus. The embedded system and the sound receiving apparatus are provided in the silencing box; and the processing apparatus is configured to log in to the embedded system in a manner of remote connection, transmit at least one first sound file to the embedded system and control the embedded system to play the at least one first sound file to generate at least one first sound signal, and receive the at least one first sound signal by means of the sound receiving apparatus, and analyze the at least one first sound signal to verify sound output quality of the embedded system.

According to the claims of the present invention, the present invention discloses a sound testing method for an embedded system. The sound testing method includes: providing the embedded system and a sound play apparatus in a silencing box; and logging in to the embedded system in a manner of remote connection by using a processing apparatus, generating at least one second sound signal to the embedded system by means of the sound play apparatus and controlling the embedded system to record the at least one second sound signal to generate at least one second sound file, and downloading the at least one second sound file from the embedded system in the manner of remote connection, and analyzing the at least one second sound file to verify sound output quality of the embedded system.

Based on the above, the sound testing system and sound testing method disclosed in the present invention can enable an embedded system without an external operating interface to be tested, and can separate a sound output from a sound input for separate tests to avoid interference, so as to resolve the foregoing problem.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified schematic diagram of a sound testing system for an embedded system of an embodiment of the present invention.

FIG. 2 is a schematic flowchart of an embodiment of a sound testing method for an embedded system according to an operating manner of the sound testing system of FIG. 1.

### DETAILED DESCRIPTION

Some words are used to refer to specific elements in the specification and claims of the present patent. A person of ordinary skill in the art may understand that hardware manufacturers may use different nouns to refer to a same element. In the specification and claims of the present patent, name differences are not used as means to distinguish elements; instead, functional differences of the elements are used as distinguishing principles. “Include” and “comprise” mentioned in the entire specification and claims are open-ended words, and therefore should be explained as “include but not limited to”.

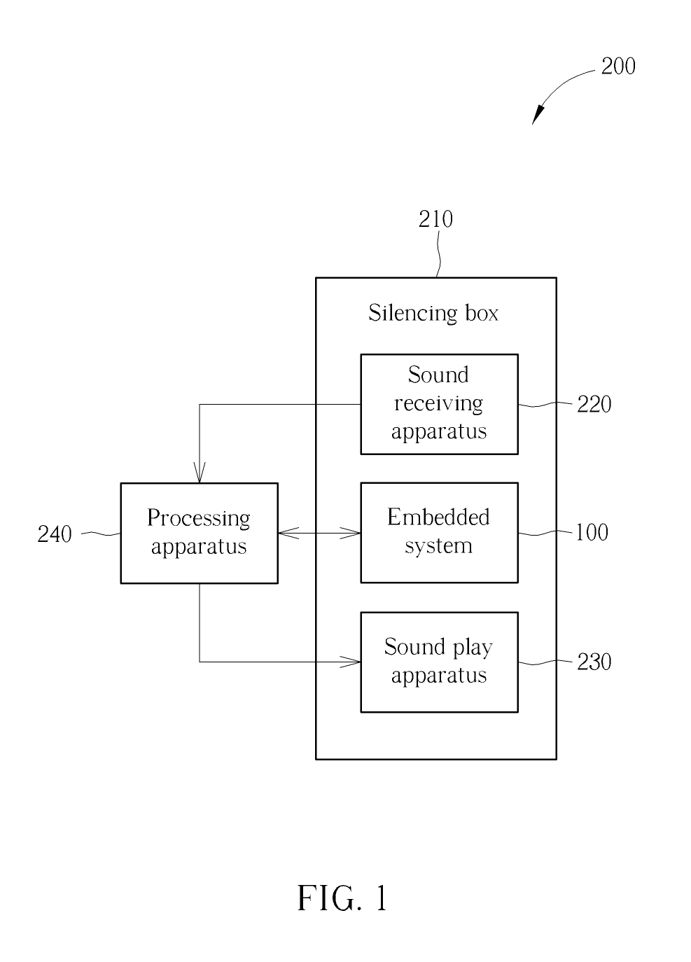

Referring to FIG. 1, FIG. 1 is a simplified schematic diagram of a sound testing system 200 for an embedded system 100 according to an embodiment of the present invention. The embedded system 100 may be various electronic apparatuses (for example, an Apple TV, a sports bracelet, or a driving warning device) without an external operating interface (for example, a button or a touch panel). As shown in FIG. 1, the sound testing system 200 includes: a silencing box 210, a sound receiving apparatus 220, a sound play apparatus 230, and a processing apparatus 240. The sound receiving apparatus 220 may be a microphone, and the sound play apparatus 230 may be a loudspeaker. The embedded system 100, the sound receiving apparatus 220, and the sound play apparatus 230 are all provided in the silencing box 210; the processing apparatus 240 is configured to log in to the embedded system 100 in a manner of remote connection, transmit at least one first sound file to the embedded system 100 and control the embedded system 100 to play the at least one first sound file to generate at least one first sound signal, and receive the at least one first sound signal by means of the sound receiving apparatus 220, and analyze the at least one first sound signal to verify sound output quality of the embedded system 100. The at least one first sound file may be a sound file of 1K Hz or 2K Hz, or a frequency scanning file of 1K Hz to 6K Hz, and the remote connection manner may be a secure shell (Secure Shell, SSH).

In addition, the processing apparatus may be further configured to generate at least one second sound signal to the embedded system 100 by means of the sound play apparatus 230, and control the embedded system 100 to record the at least one second sound signal to generate at least one second sound file, and download the at least one second sound file from the embedded system 100 in the manner of remote connection, and analyze the at least one second sound file to verify the sound output quality of the embedded system 100. The at least one second sound signal may be a sound of 1K Hz or 2K Hz, or a frequency scanning sound of 1K Hz to 6K Hz, and the remote connection manner may be a secure shell (Secure Shell, SSH). In this way, the sound testing system 200 of the present invention can enable the embedded system 100 without an external operating interface to be tested, and can separate a sound output from a sound input for separate tests to avoid interference.

It should be noted herein that the foregoing embodiments are merely used as illustrative description of the present invention, rather than limiting conditions of the present invention. For example, in other embodiments, the sound testing system 200 may only include the sound receiving apparatus 220 or only include the sound play apparatus 230 according to different design requirements.

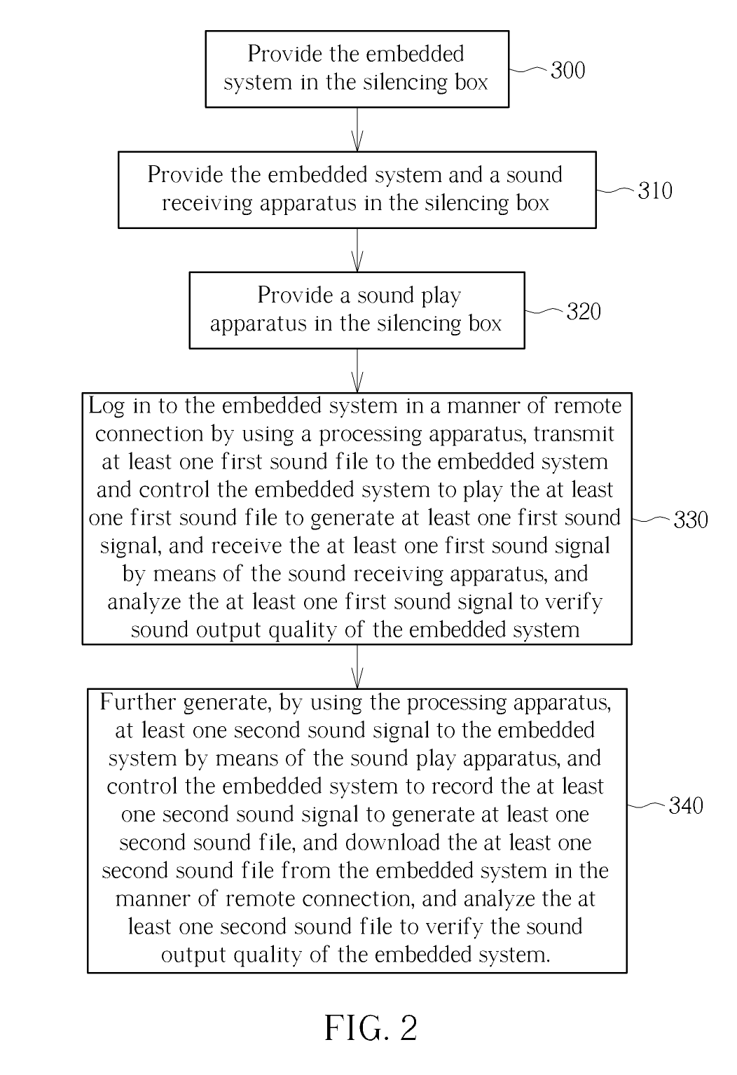

Referring to FIG. 2, FIG. 2 is a schematic flowchart of an embodiment of a sound testing method for an embedded system according to an operating manner of the foregoing sound testing system 200. If generally, a same result can be obtained, steps in the flow do not need to be executed according to the sequence shown in FIG. 2, and do not have to be continuous, that is, other steps may be inserted into the steps. The sound testing method of the present invention includes the following steps.

Step 300: Provide the embedded system in the silencing box.
Step 310: Provide the embedded system and a sound receiving apparatus in the silencing box.
Step 320: Provide a sound play apparatus in the silencing box.
Step 330: Log into the embedded system in a manner of remote connection by using a processing apparatus, transmit at least one first sound file to the embedded system and control the embedded system to play the at least one first sound file to generate at least one first sound signal, and receive the at least one first sound signal by means of the sound receiving apparatus, and analyze the at least one first sound signal to verify sound output quality of the embedded system.
Step 340: Further generate, by using the processing apparatus, at least one second sound signal to the embedded system by means of the sound play apparatus, and control the embedded system to record the at least one second sound signal to generate at least one second sound file, and download the at least one second sound file from the embedded system in the manner of remote connection, and analyze the at least one second sound file to verify the sound output quality of the embedded system.

It should be noted herein that the foregoing embodiments are merely used as illustrative description of the present invention, rather than limiting conditions of the present invention. For example, in other embodiments, the sound testing method may only include step 300, step 310, and step 330, or only include step 300, step 320, and step 340 according to different design requirements.

Based on the above, the sound testing system and sound testing method disclosed in the present invention can enable an embedded system without an external operating interface to be tested, and can separate a sound output from a sound input for separate tests to avoid interference, so as to resolve the foregoing problem.

The foregoing are merely preferred embodiments of the present invention, and any equivalent variation and modification made according to the claims of the present invention shall fall within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

1. A sound testing system for an embedded system, comprising:
a silencing box, wherein the embedded system is provided in the silencing box;
a sound receiving apparatus, provided in the silencing box; and
a processing apparatus, configured to log in to the embedded system in a manner of remote connection, transmit at least one first sound file to the embedded system and control the embedded system to play the at least one first sound file to generate at least one first sound signal, and receive the at least one first sound signal by means of the sound receiving apparatus, and analyze the at least one first sound signal to verify sound output quality of the embedded system.

2. The sound testing system according to claim 1, further comprising:
a sound play apparatus, provided in the silencing box, wherein
the processing apparatus is further configured to generate at least one second sound signal to the embedded system by means of the sound play apparatus, and control the embedded system to record the at least one second sound signal to generate at least one second sound file, and download the at least one second sound file from the embedded system in the manner of remote connection, and analyze the at least one second sound file to verify the sound output quality of the embedded system.

3. The sound testing system according to claim 1, wherein the remote connection manner is a secure shell (Secure Shell, SSH).

4. A sound testing method for an embedded system, comprising:
providing the embedded system and a sound receiving apparatus in the silencing box; and
logging in to the embedded system in a manner of remote connection by using a processing apparatus, transmitting at least one first sound file to the embedded system and controlling the embedded system to play the at least one first sound file to generate at least one first sound signal, and receiving the at least one first sound signal by means of the sound receiving apparatus, and analyzing the at least one first sound signal to verify sound output quality of the embedded system.

5. The sound testing method according to claim 1, further comprising:
providing a sound play apparatus in the silencing box; and
further generating, by using the processing apparatus, at least one second sound signal to the embedded system by means of the sound play apparatus, and controlling the embedded system to record the at least one second sound signal to generate at least one second sound file, and downloading the at least one second sound file from the embedded system in the manner of remote connection, and analyzing the at least one second sound file to verify the sound output quality of the embedded system.

6. The sound testing method according to claim 1, wherein the remote connection manner is a secure shell (Secure Shell, SSH).

7-10. (canceled)
